(19) United States
(12) Patent Application Publication
(10) Pub. No.: US 2017/0241634 A1
(43) Pub. Date: Aug. 24, 2017

(54) Light Emitting Wrist Band Assembly

(71) Applicant: Richard Almaraz, San Antonio, TX (US)

(72) Inventor: Richard Almaraz, San Antonio, TX (US)

(21) Appl. No.: 15/052,856

(22) Filed: Feb. 24, 2016

(51) Int. Cl. F21V 33/00; F21V 23/04; A45F 5/00; F21L 4/02

(52) U.S. Cl. CPC F21V 33/0008; F21L 4/02; F21V 23/04; A45F 5/00; A45F 2005/008

(57) ABSTRACT

A light emitting wrist band assembly includes a wrist band that may be worn. The wrist band comprises a magnet that is coupled to the wrist band. The magnet magnetically retains ferromagnetic objects on the wrist band. A plurality of light emitters is provided and each of the light emitters is coupled to the wrist band. Each of the light emitters emits light. A switch is coupled to the wrist band and the switch may be manipulated. The switch turns the light emitters on and off.

### BACKGROUND OF THE DISCLOSURE

### Field of the Disclosure

The disclosure relates to wrist band devices and more particularly pertains to a new wrist band device for facilitating hands free illumination while performing work.

### SUMMARY OF THE DISCLOSURE

An embodiment of the disclosure meets the needs presented above by generally comprising a wrist band that may be worn. The wrist band comprises a magnet that is coupled to the wrist band. The magnet magnetically retains ferromagnetic objects on the wrist band. A plurality of light emitters is provided and each of the light emitters is coupled to the wrist band. Each of the light emitters emits light. A switch is coupled to the wrist band and the switch may be manipulated. The switch turns the light emitters on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a light emitting wrist band assembly according to an embodiment of the disclosure.

FIG. 2 is a back view of an embodiment of the disclosure.

FIG. 3 is a bottom view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DESCRIPTION OF THE PREFERRED EMBODIMENT

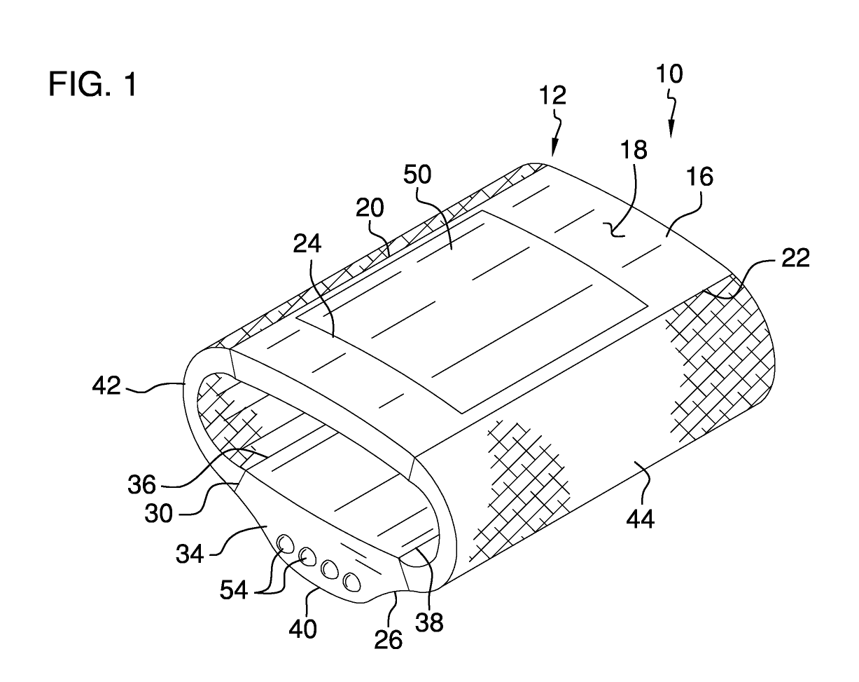

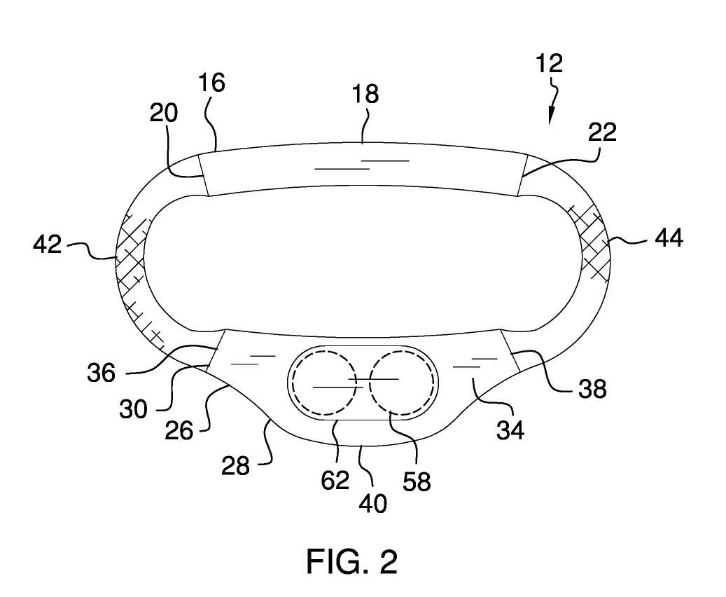

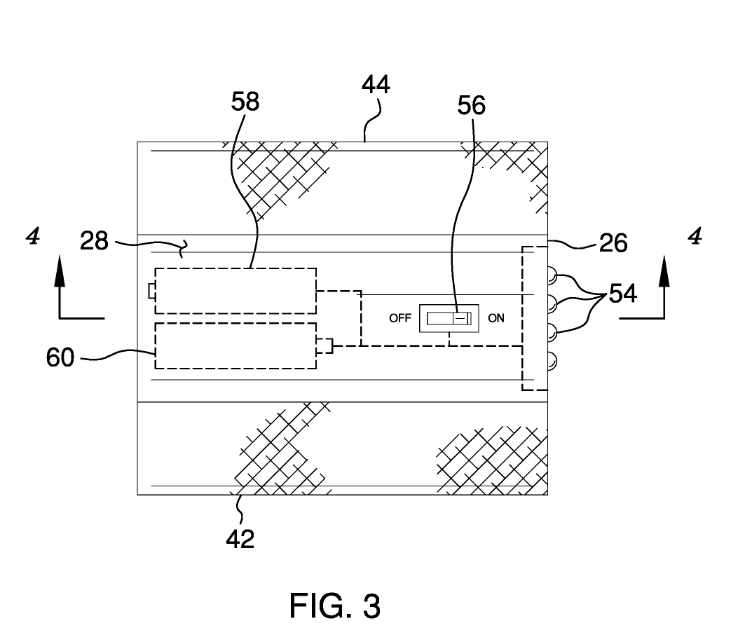

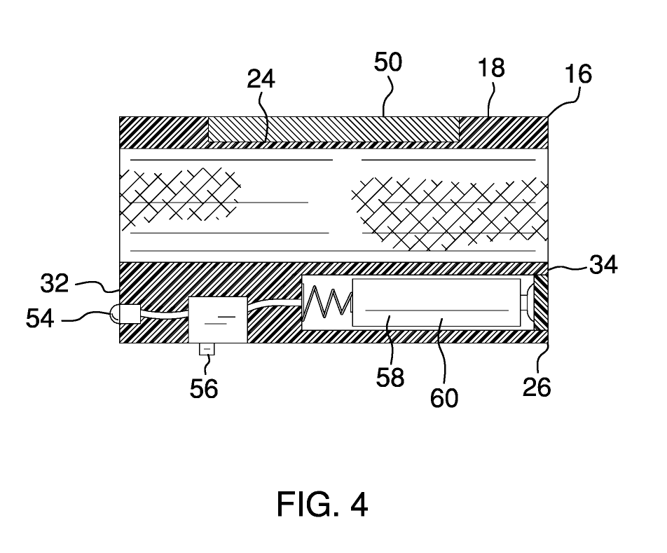

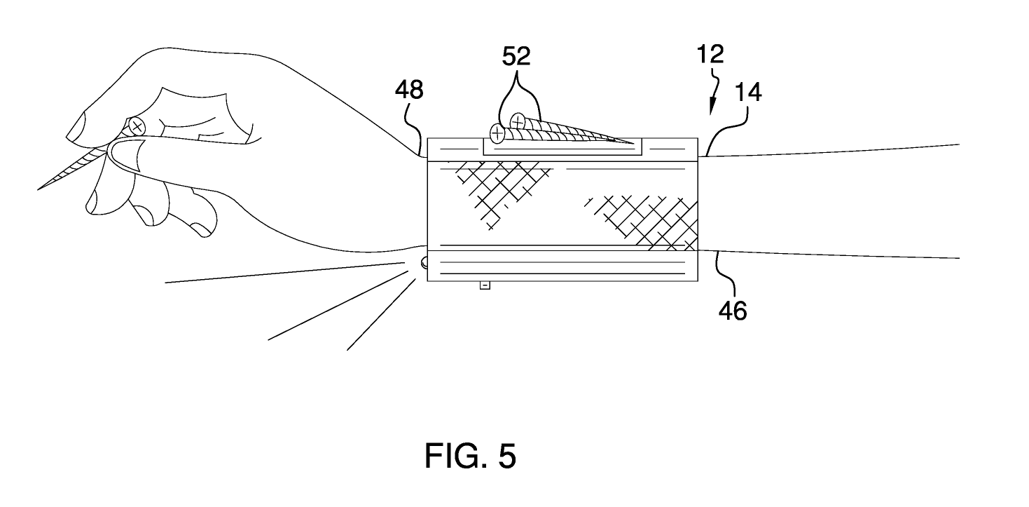

With reference now to the drawings, and in particular to FIGS. 1 through 5 thereof, a new wrist band device embodying the principles and concepts of an embodiment of the disclosure and generally designated by the reference numeral 10 will be described.

As best illustrated in FIGS. 1 through 5, the light emitting wrist band assembly 10 generally comprises a wrist band 12 that may be worn on a wrist 14 of a user. The wrist band 12 comprises a first panel 16 that has a top surface 18, a first lateral edge 20 and a second lateral edge 22. The top surface 18 has a well 24 extending inwardly therein. The first panel 16 may be comprised of a fluid impermeable material.

A second panel 26 is provided that has a bottom surface 28 and a peripheral edge 30. The peripheral edge 30 has a front side 32, a back side 34, a first lateral side 36 and a second lateral side 38. The bottom surface 28 has a prominence 40 extending between the front side 32 and the back side 34. The prominence 40 is centrally positioned on the bottom surface 28. The second panel 26 may be comprised of a fluid impermeable material.

A first elastic member 42 is provided. The first elastic member 42 is coupled between the first lateral edge 20 and the first lateral side 36. The first elastic member 42 is comprised of a resiliently stretchable material. A second elastic member 44 is coupled between the second lateral edge 22 and the second lateral side 38. The second elastic member 44 is comprised of a resiliently stretchable material. Each of the first elastic member 42 and the second elastic member 44 are coextensive with the first panel 16 and the second panel 26.

Each of the first elastic member 42 and the second elastic member 44 bias the first panel 16 toward the second panel 26 when the wrist band 12 is worn. Thus, each of the first elastic member 42 and the second elastic member 44 retain the wrist band 12 on the wrist 14. The second panel 26 is positioned on a bottom 46 of the wrist 14 thereby facilitating the front side 32 to be directed toward a hand. The first panel 16 is positioned on a top 48 of the wrist 14.

A magnet 50 is coupled to the wrist band 12 and the magnet 50 magnetically retains ferromagnetic objects 52 on the wrist band 12. The ferromagnetic objects 52 may comprise nuts, bolts or ferromagnetic components of a machine. The magnet 50 is positioned in the well 24 in the first panel 16. Thus, the magnet 50 is positioned on the top 48 of the wrist 14 when the wrist band 12 is worn.

A plurality of light emitters 54 is provided. Each of the light emitters 54 is coupled to the wrist band 12 and each of the light emitters 54 may emit light. Each of the light emitters 54 is positioned on the front side 32 of the second panel 26. Thus, each of the light emitters 54 may emit light toward the hand when the wrist band 12 is worn. Each of the light emitters 54 may comprise an LED or the like.

A switch 56 is provided and the switch 56 is coupled to the wrist band 12. Thus, the switch 56 may be manipulated. The switch 56 is electrically coupled to each of the light emitters 54 such that the switch 56 turns the light emitters 54 on and off. The switch 56 may be positioned on the prominence 40 of the second panel 26.

A power supply 58 is positioned within the second panel 26. The power supply 58 is electrically coupled to the switch 56. The power supply 58 comprises at least one battery 60. A battery cover 62 is removably coupled to the back side 34 of the second panel 26. The power supply 58 is positioned behind the battery cover 62.

In use, the wrist band 12 is worn while performing repair or other work. The ferromagnetic objects 52 are placed on the magnet 50 while the work is performed. Thus, the magnet 50 inhibits the ferromagnetic objects 52 from being misplaced while the work is performed. The switch 56 is selectively manipulated to turn the light emitters 54 on. Thus, the light emitters 54 illuminate the work being performed. The light emitters 54 facilitate hands free illumination of the work being performed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light emitting wrist band assembly comprising:
a wrist band being configured to be worn, said wrist band comprising:
a magnet being coupled to said wrist band wherein said magnet is configured to magnetically retain ferromagnetic objects on said wrist band;
a plurality of light emitters, each of said light emitters being coupled to said wrist band wherein each of said light emitters is configured to emit light;
a switch being coupled to said wrist band wherein said switch is configured to be manipulated, said switch turning said light emitters on and off.

2. The assembly according to claim 1, wherein said wrist band comprises:
a first panel having a top surface, a first lateral edge and a second lateral edge, said top surface having a well extending inwardly therein; and
a second panel having a bottom surface, and a peripheral edge, said peripheral edge having a front side, a back side, a first lateral side and a second lateral side, said bottom surface having a prominence extending between said front side and said back side, said prominence being centrally positioned on said bottom surface.

3. The assembly according to claim 2, wherein said magnet is positioned in said well in said first panel wherein said magnet is configured to be positioned on a top of the wrist when said wrist band is worn.

4. The assembly according to claim 2, further comprising a first elastic member being coupled between said first lateral edge and said first lateral side.

5. The assembly according to claim 4, further comprising a second elastic member being coupled between said second lateral edge and said second lateral side, each of said first elastic member and said second elastic member biasing said first panel toward said second panel when said wrist band is worn wherein each of said first elastic member and said second elastic member is configured to retain said wrist band on a wrist having said second panel being positioned on a bottom of the wrist thereby facilitating said front side to be directed toward a hand.

6. The assembly according to claim 2, wherein each of said light emitters is positioned on said front side of said second panel wherein each of said light emitters is configured to emit light toward the hand when said wrist band is worn.

7. The assembly according to claim 6, wherein said switch is electrically coupled to each of said light emitters such that said switch turns said light emitters on and off, said switch being positioned on said second panel.

8. The assembly according to claim 7, further comprising a power supply being positioned within said second panel, said power supply being electrically coupled to said switch, said power supply comprising at least one battery.

9. A light emitting wrist band assembly comprising:
a wrist band being configured to be worn, said wrist band comprising:
a first panel having a top surface, a first lateral edge and a second lateral edge, said top surface having a well extending inwardly therein,
a second panel having a bottom surface, and a peripheral edge, said peripheral edge having a front side, a back side, a first lateral side and a second lateral side, said bottom surface having a prominence extending between said front side and said back side, said prominence being centrally positioned on said bottom surface,
a first elastic member being coupled between said first lateral edge and said first lateral side, and
a second elastic member being coupled between said second lateral edge and said second lateral side, each of said first elastic member and said second elastic member biasing said first panel toward said second panel when said wrist band is worn wherein each of said first elastic member and said second elastic member is configured to retain said wrist band on a wrist having said second panel being positioned on a bottom of the wrist thereby facilitating said front side to be directed toward a hand;
a magnet being coupled to said wrist band wherein said magnet is configured to magnetically retain ferromagnetic objects on said wrist band, said magnet being positioned in said well in said first panel wherein said magnet is configured to be positioned on a top of the wrist when said wrist band is worn;
a plurality of light emitters, each of said light emitters being coupled to said wrist band wherein each of said light emitters is configured to emit light, each of said light emitters being positioned on said front side of said second panel wherein each of said light emitters is configured to emit light toward the hand when said wrist band is worn;
a switch being coupled to said wrist band wherein said switch is configured to be manipulated, said switch being electrically coupled to each of said light emitters such that said switch turns said light emitters on and off, said switch being positioned on said second panel; and
a power supply being positioned within said second panel, said power supply being electrically coupled to said switch, said power supply comprising at least one battery.
